(19) United States
(12) Patent Application Publication
(10) Pub. No.: US 2007/0038525 A1
(43) Pub. Date: Feb. 15, 2007

(54) Systems and Methods of Managing Retailer Affiliate Programs

(76) Inventors: Richard Thomas Waldvogel, Longmont, CO (US); Daniel Richard Werling, Monument, CO (US)

Correspondence Address: TRENNER LAW FIRM, LLC, 12081 WEST ALAMEDA PARKWAY #163, LAKEWOOD, CO, 80228, US

(21) Appl. No.: 11/464,194

(22) Filed: Aug. 12, 2006

Related U.S. Application Data
(60) Provisional application No. 60/708,139, filed on Aug. 15, 2005.

(51) Int. Cl. G06Q 30/00

(52) U.S. Cl. 705/26

(57) ABSTRACT

Systems and methods for managing retailer affiliate programs are disclosed. In an exemplary implementation, a method may include generating a plurality of tokens, each token uniquely identifying individual service providers enrolled in an affiliate program. The method may also include generating a plurality of unique sub-token for each of the plurality of tokens, the unique sub-tokens assigned to separate organizations. The method may also include brokering transactions by the service providers on behalf of at least one retailer. The method may also include crediting a portion of proceeds from the brokered transactions: 1) to the service providers based on the tokens associated with the brokered transactions, and 2) to the organizations based on the unique sub-tokens associated with the brokered transactions.

### PRIORITY CLAIM

This application claims priority to co-owned U.S. Provisional Patent Application No. 60/708,139 for “Systems and Methods of Managing Retailer Affiliate Programs” of Waldvogel, et al., filed Aug. 15, 2005, hereby incorporated by reference in its entirety as though fully set forth herein.

### BACKGROUND

Electronic commerce (or “e-commerce” as it is commonly referred to) continues to be a powerful marketplace for goods and services. Today, an e-commerce consumer can purchase nearly anything online that can be purchased at a traditional “brick-and-mortar” store. There are e-commerce websites that only exist online (e.g., www.amazon.com), and there are e-commerce websites that offer everything or nearly everything that is offered in the corresponding brick-and-mortar store (e.g., www.barnesandnobel.com, www.target.com, and www.homedepot.com).

Various organizations may also offer products for sale on their own websites. For example, colleges and universities often offer school memorabilia (e.g., hats, sweatshirts, etc.) for sale on their websites. As another example, non-profit organizations may sell products (e.g., t-shirts, posters, etc.) on their websites to promote their cause and/or for fundraising. These organizations typically must develop and manage elaborate e-commerce websites in order to offer and sell products. This can be time-consuming and expensive. Indeed, the time and cost may be prohibitive to organizations without the budget to support their own e-commerce site.

Instead of developing and managing their own e-commerce site, some organizations partner with large or commercial e-commerce sites to have their products marketed. However, the organizations cannot control the products being offered for sale at the commercial e-commerce site, and members of the organization or people shopping on behalf of the organization may find some of the products objectionable.

### BRIEF DESCRIPTION OF THE DRAWINGS

FIG. 1 is a high-level schematic illustration of an exemplary computer network which may be implemented for managing retailer affiliate programs.

FIG. 2 is another high-level schematic illustration of the exemplary computer network shown in FIG. 1 illustrating exemplary operations for managing retailer affiliate programs.

FIGS. 3a and 3b are screenshots showing an exemplary browser interface which may be implemented for managing retailer affiliate programs, wherein (a) shows an exemplary non-profit website with a shopping link, and (b) shows the exemplary non-profit storefront accessed from the shopping link.

FIG. 4 is a flowchart illustrating exemplary operations which may be implemented by a service provider for an organization to establish or modify/update a storefront.

FIG. 5 is a flowchart illustrating exemplary operations which may be implemented by a service provider to track a user's purchases and distribute payment to the organization(s) selected by the user.

### DETAILED DESCRIPTION

Systems and methods for managing retailer affiliate programs are disclosed. In an exemplary embodiment, an organization desiring to offer products and/or services for sale to benefit the organization is able to provide these products and/or services for sale from a commercial e-commerce site at their own website or “storefront”. The storefront can be customized for the organization and displays products and/or services for sale that have been selected by the organization from one or more commercial e-commerce sites (referred to as “retailer” or “retailers”). Accordingly, the organization is able to offer select products and/or services from a broad range of available products and/or services that are consistent with the organizations ideals and goals, but without having to develop and manage their own e-commerce site or handle transactions with consumers (e.g., warehousing, payment, and shipping).

Exemplary systems and methods may also provide organizations all opportunity to generate financial support by participating in retailer-sponsored reward programs or “affiliate programs” for referring business to the retailer. By way of example the organization may sell products for the retailer through the storefront. Or for example, the organization may recommend products for sale on the retailer's e-commerce site. In any event a retailer may pay a percentage of the purchase price to the organization for each product the referred consumer purchases, whether it is via the organization's storefront or directly from the retailers e-commerce site.

Exemplary Systems

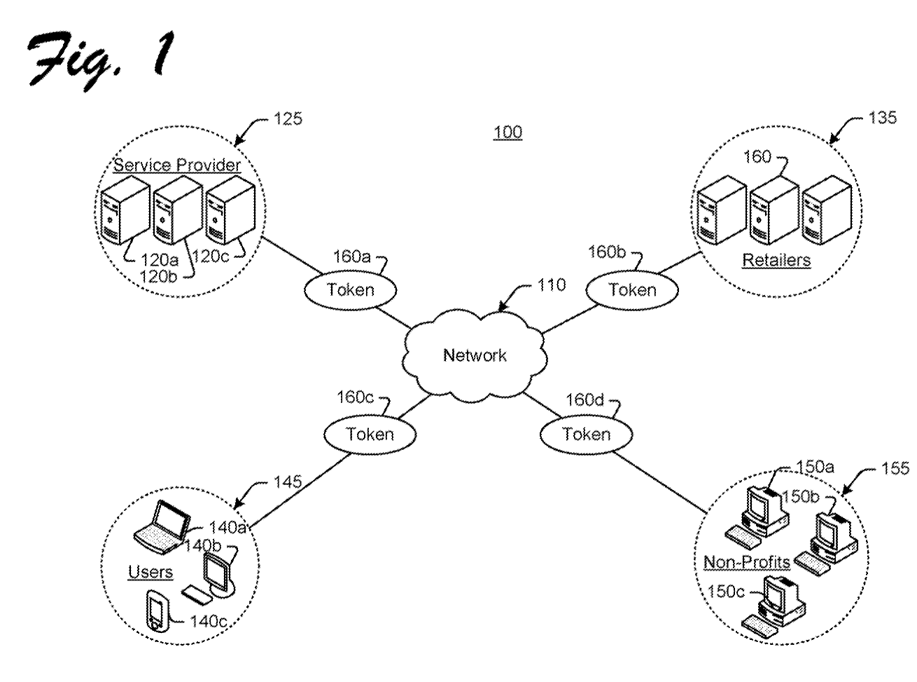

FIG. 1 is a high-level illustration of an exemplary networked computer system 100 (e.g., via the Internet) which may be implemented for managing retailer affiliate programs. The networked computer system 100 may include one or more communication networks 110, such as a local area network (LAN) and/or wide area network (WAN) for connecting one or more service provider 125, one or more retailers 135, one or more users 145, and one or more organizations 155.

In an exemplary embodiment, a service provider 125 may be any entity that provides and maintains an affiliate program for the promotion of goods and services. The service provider 125 serves as a proxy between the retailer 135 and the organization 155. That is, the service provider 125 provides the technology and hardware/software services to consume and interact with the retailer's 135 affiliate program on behalf of the organization 155.

A retailer 135 is a business entity that offers products and/or services for sale (lease, donation, etc.) and makes these products and/or services available to consumers 145 on behalf of one or more organizations 155 through the affiliate program via the service provider 125. The retailer 135 provides compensation to the service provider 125 for products purchased or services purchased at their e-commerce site and/or brick-and-mortar store that have been referred to them by the organization 155 via the service provider 125.

A user 145 may be any individual or group of individuals (e.g., a donor, constituent, customer, or supporter of the organization 155) that is interacting with the organization's 155 site hosted by the service provider 125. The user 145 selects products for purchase from the retailer 135 that have been made available by the organization 155 via the service provider 125. The purchase transactions made by the user 145 are processed and recorded by the retailer 135 and are referenced by the service provider 125 so that referral fees can be distributed to the organization 155.

An organization 155 may be any individual, group, or organization. In an exemplary embodiment, the organization is a non-profit organization having section 501.3(c) tax status from the United States government. However, other embodiments are also contemplated, and the organization 155 is not limited to such non-profit organizations. The organization 155 registers with the service provider 125 to provide products and/or services that users 145 can purchase via the retailer's affiliate program.

The operations described herein may be implemented by host computers and client computers in the networked computer system 100. For purposes of illustration, host computers 120a-c are shown in the networked computer system 100 for a service provider 125, and host computers 130a-c are shown for a retailer 135. Also for purposes of illustration client computers 140a-c are shown in the networked computer system 100 for a user 145, and client computers 150a-c are shown for organization 155.

Host computers (or “hosts”) may include one or more computing, systems, such as a server with computer-readable storage. The hosts may be provided on the network 110 via a communication connection such as a dial-up, cable, or DSL connection via an Internet service provider (ISP). The hosts may be accessed directly via the network 110 or via a network site. In an exemplary embodiment, the network site may also include a web portal on a third-party venue (e.g., a commercial Internet site), which facilitates a connection for one or more clients with host (e.g., via a back-end link). In another exemplary embodiment, portal icons may be provided (e.g., on third-party venues) pre-installed on computer or appliance desktops, etc.) to facilitate a direct link to the host.

Hosts may execute one or more host applications implemented in software, as described in more detail below. The hosts may also provide services to other computing or data processing systems or devices. For example, hosts may also provide transaction processing services, email services, etc.

By way, of example, the service provider hosts 20a-c may be implemented for returning data to a user 145 in a format that is specific to the organization 155 that has been selected by the user 145. For example, a user 145 may select an organization 155 to which their purchases are to be credited. The host at the service provider 125 retrieves data that are representative to the selected organization 155 (e.g., the storefront, including logos, colors, and other information) and formats the data according to the organization's 155 configurations. Accordingly, the user 145 is assured that any transactions will be credited to the organization 155 that they have selected.

The term “client” as used herein refers to a computing device through which one or more users (e.g., consumers) or representatives of the organization 155 (e.g., administrators) may access the network 110. Clients may include any of a wide variety of computing systems, such as a stand-alone personal desktop or laptop computer (PC), workstation, personal digital assistant (PDA), (or appliance, to name only a few examples. Each of the client computing devices may include memory, storage, and a degree of data processing capability at least sufficient to manage a connection to the network 110, either directly or indirectly. Client computing devices may connect to network 110 via a communication connection, such as a dial-up, cable, or DSL connection via an internet service provider (ISP).

Before continuing, it is also noted that various data relating to the service provider 125, the retailer 135, the user 145, and the organization 155 may be stored in the respective storage systems. Any storage technology may be implemented for this purpose, such as, e.g., a Microsoft® SQL server product, Oracle, DB2, MySQL, or AS400, to name only a few examples. Types of data may include, but are not limited to, contact information related to the organizations, product and/or services data (e.g., uploaded by the retailer 135 via a product data feed to the service provider 125), transactions (e.g., sales), etc.

In an exemplary embodiment, communications between the service provider 125, the retailer 135, the user 145 and the organization 155 are token-based (e.g., as illustrated in FIG. 1 by the tokens 160a-d). That is, a unique token is embedded in communications.

The use of tokens 160a-d helps ensure that the transactions are properly monitored and credited appropriately (e.g., when determining compensation for participants in the affiliate program). For example, if a user 145 purchases a product from a retailer 135 through the affiliate program, a token 160a-d is associated with the transaction. The retailer 135 uses that token 160a-d to compensate the service provider 125 for the commissions earned for referring that product and/or service. The service provider 125 may also use that information to distribute earnings to the respective organizations 155 for generating the referral to the retailer 135.

A token 160a-d may include any type of data that is used for the unique identification of a set of data. For example, a token 160a-d may be a unique reference used to identify transactions performed between networked systems. A token 160a-d may also be a unique reference that is assigned to the service provider 125 and/or organization 155 that is used to identify and reference a specific set of data related to the service provider 125 and/or organization 155. A token 160a-d may also be a collection of unique identifiers. For example, a token 160a-d may contain a list of product ID's or a list of other parameters that the service provider 125 is tracking for the user 145, organization 155, or retailer 135. For example, the token 160a-d may contain a unique identifier for the user 145 that informs the service provider 125 which organization 155 is currently selected to receive credit for the user's 145 transactions with the retailer 135.

Still other embodiments of the tokens 160a-d are also contemplated. For example a token 160a-d may be a unique phone number or text message number. Accordingly, users 145 can call or text message the token number and generate revenue for the organization 155 assigned the unique number.

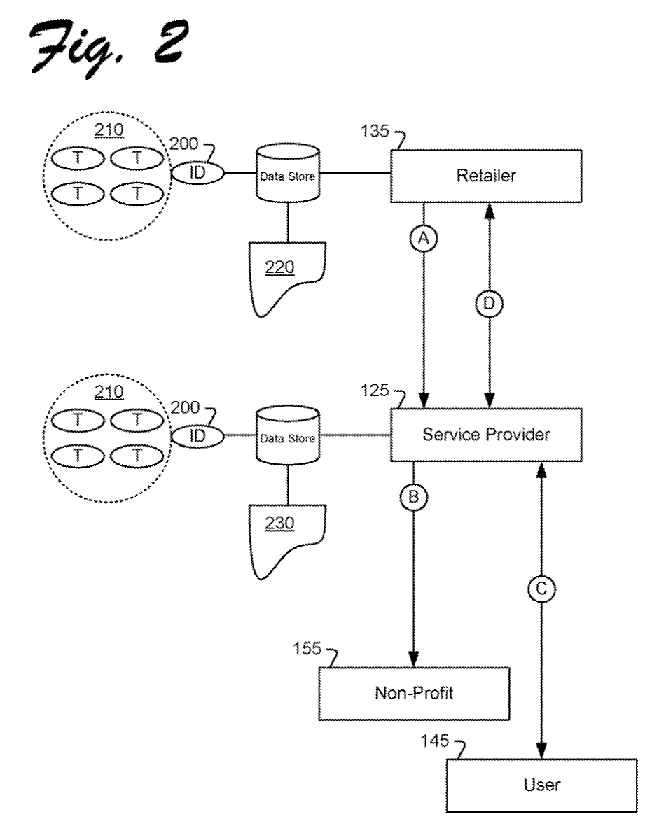

Token-based communication is explained in more detail below with reference to the exemplary embodiment shown in FIG. 2. FIG. 2 is another high-level schematic illustration of the exemplary computer network shown in FIG. 1 illustrating exemplary operations for managing retailer affiliate programs.

When a service provider 125 enrolls in a retailer's affiliate program, the retailer 135 assigns a master ID token 200 and a set of unique sub-tokens 210 to the service provider 125. The master ID token 200 identifies the service provider's account 220 with the retailer 135. For example, the master ID token 200 may be in the format of “ABC123” and the corresponding sub-tokens 210 may be in the format of “ABC123-1”, “ABC123-2”, “ABC123-3”, etc. The retailer 135 may use this information to iniquely identify the transactions at its system by the user 145 via the service provider 125.

The master ID token 200 and set of unique sub-tokens 210 are provided to the service provider 125 (as illustrated in FIG. 2 by communications A between the retailer 135 and service provider 125). Optionally, the service provider 125 may generate sub-tokens 210 and deliver these to the retailer 135. Alternatively, a third party may generate sub-tokens 210 and deliver these to the service provider 125 and/or retailer 135. The service provider 135 may also distribute the sub-tokens 210 to its subscribers (as illustrated in FIG. 2 by communications B between the service provider 125 and the organization 155).

When an organization 155 subscribes to a retailer affiliate program, the service provider 125 assigns one of the unique sub-tokens 210 to the organization. For example if two organizations subscribe through the same service provider 125 (having master ID “ABC123”), one organization 155 may be assigned sub-token “ABC123-1”, while another organization 155 may be assigned sub-token “ABC123-2”. Organizations 155 (even the same organizations) subscribed through another service provider are assigned different sub-tokens, such as, e.g., “DEF123-1” and “DEF123-2”. The unique sub-token 210 identifies the organization's account 230 with the service provider 155.

During operation, the sub-token 210 assigned to the organization 155 is referenced by the service provider 125 and passed during corresponding transactions with the retailer 135.

For example, the user 145 may access an organization's storefront via the service provider 125 (as illustrated in FIG. 2 by communications C between the user 145 and the service provider 125). The service provider 125 identifies the organization's account 230 and associates the organization's sub-token 210 with the user's transactions. When the user makes a purchase from retailer 135 (as illustrated in FIG. 2 by communications D between the service provider 125 and the retailer 135), the purchase can be properly credited to the organization 155 selected by the user 145.

The retailer's earnings from the affiliate program may be tracked and a portion disbursed to the service provider 125, and in turn to the organization(s) 155 subscribed through the service provider 125. For example, a retailer may calculate the commissions earned by the service provider 125 for the tracked transactions (i.e. product purchase referrals) performed by the service provider 125 at its system. The retailer 135 may then distribute those earnings to the service provider 125 by one of several available methods, such as, e.g., direct deposit, check, gift certificate, store credits to name just a few examples.

After the service provider 125 obtains payment for the commissions earned through its participation in the retailer's affiliate program, the service provider 125 may calculate and summarize the earnings that were generated by each token and use that token data to cross reference the organization 155 responsible for generating the commission through the service provider 125. The service provider 125 may then provide the subscribed organizations with a percentage of the total earnings generated at the retailer 135 and distribute those earnings to the organizations 155 by several different methods, such as, e.g., direct deposits, check, gift certificates, store credit, etc.

Optionally, the service provider 125 may distribute the funds equally to all the organizations 155 or target specific organizations 155 to receive the generated funds. The distribution of funds can also be adjusted by performance parameters such as, e.g., purchase volume or user activity.

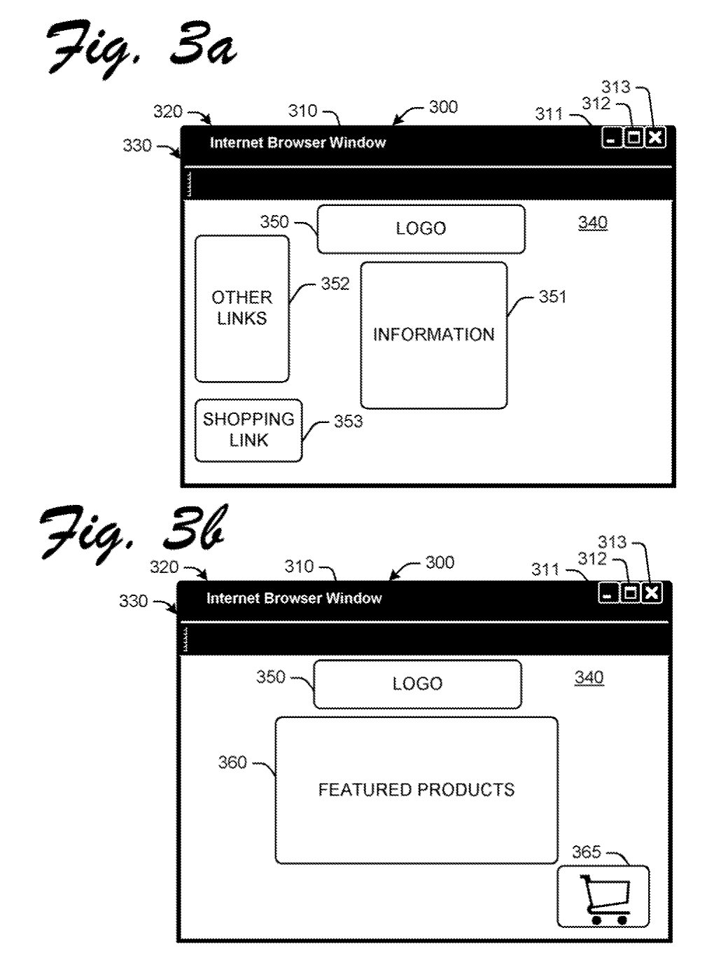

FIGS. 3a and 3b are screenshots showing an exemplary browser interface 300 which may be implemented for managing retailer affiliate programs, wherein (a) shows an exemplary non-profit website with a shopping link, and (b) shows the exemplary non-profit storefront accessed from the shopping link.

In an exemplary embodiment, the browser interface 300 may be implemented as a graphical user interface (GUI) in a “windows-based” operating system environment (e.g., Microsoft Corporation's WINDOWS®), although the browser interface 300 is not limited to use with any particular operating system. The user may launch the browser interface 300 in a customary manner, for example, by clicking on an icon, selecting the program from a menu, or pressing a key on a keyboard.

The browser interface 300 supports user interaction through common techniques, such as a pointing device (e.g., mouse, style), keystroke operations, or touch screen. By way of illustration, the user may make selections using a mouse to position a graphical pointer and click on a label or button displayed in the browser interface 300. The user may also make selections by entering a letter for a menu label while holding the ALT key (e.g., “ALT+letter” operation) on a keyboard. In addition, the user may use a keyboard to enter command strings (e.g., in a command window).

The browser interface 300 is displayed for the user in a window, referred to as the “application window” 310, as is customary in a window environment. The application window 310 may include customary window functions, such as a Minimize Window button 311, a Maximize Window button 312, and a Close Window button 313. A title bar 320 identifies the application window 310 for the user (e.g., as “Internet Browser Window”). The application window 310 may also include a customary menu bar 330 having an assortment of pull down menus (e.g., labeled “File,” “Edit,” “View,” “Go,” “Bookmarks,” “Tools,” and “Help”), which are well-known in commercially available browser interfaces 300. For example, the user may select a print function (not shown) from the “File” menu (designated herein as “File Print”).

Application window 310 also includes an operation space 340. Operation space 340 may include one or more graphics for displaying output and/or facilitating input from the user. In FIG. 3a, the graphics include a logo 350 for the organization, information 351 about the organization (e.g., a mission statement), links 352 to web pages and/or websites, and a shopping link 353. Although not shown, the graphics may also include, but are not limited to, subordinate windows, dialog boxes, icons, text boxes, buttons, and check boxes.

By selecting the shopping link 353, the user may be directed to the organization's storefront, as illustrated in FIG. 3b. In an exemplary embodiment, the organization's storefront may be assigned a unique Uniform Resource Locator (URL) that enables users to directly access their customized web site via the service provider. The URL may be in a format that uniquely identifies the organization within the service provider system.

Any of several different methods may be implemented to provide this service for the organization. One example may include appending a unique identifier to the base URL of the service provider, resulting in a URL such as www.serviceprovider.com/organizationID. In this example, the “organizationID” at the end of the URL is the unique identifier assigned, stored and used to reference the organization's customization data selections. In another embodiment, a unique URL may point to the service provider system to retrieve the organization's preferences data when a User session is initiated. For example, a URL may be registered such as www.shoporganizationID.com that points to the service provider system representative of the organization.

The storefront may be customized for the organization. For example, various text and/or media (e.g., a logo, colors, or layout of the organization's website to match the organization's branding materials) may be used to identify the organization to users. The organization may also maintain community-based tools on its storefront, such as, but not limited to, online journals, photo albums, guest books and forums, to name a few examples. This information may be stored by the service provider and retrieved when requests by users include tokens that identify the corresponding organization.

The exemplary storefront shown in FIG. 3b includes the organization's logo 350, in addition to featured products 360, and a shopping cart icon 365 for making purchases. Although the featured products 360 are displayed for the user in the browser interface 300 via the organization's storefront, the featured products 360 are actually available for purchase via a retailer (or retailers) and not directly from the organization.

The method for retrieving the information from the retailer may vary by implementation. For example, a suer at the service provider system may request to see a list of products available for sale from the retailer. The service provider accepts the request from the user and then makes a request to the retailer to obtain a product and/or service information from the retailer to display for the user. Alternatively, product and/or service information may be stored locally by the service provider and updated at various intervals (or on request), so that the service provider can display this information for the user without having to query the retailer while the user waits. In any event, it can be appreciated that the organization does not need to manage their own e-commerce website in order to offer selected products for sale via the organization's own website.

Although the systems and methods have been described above with reference to e-commerce, it is noted that in other embodiments a web-based storefront is not necessary for implementing the systems and methods described herein. Optionally, the user may reference the organization during transactions at a retailer's brick-and-mortar store. During the checkout process, the user may present a token to the cashier or point of sale system to identify the organization. The token may be embedded, e.g., in an RFID card, bar-coded card, etc.

Before continuing, it is noted that the systems shown and described above with reference to the figures are merely exemplary of systems which may be implemented for managing retailer affiliate programs, and are not intended to be limiting. Other embodiments of systems which may be implemented for managing retailer affiliate programs are also contemplated.

Exemplary Operations

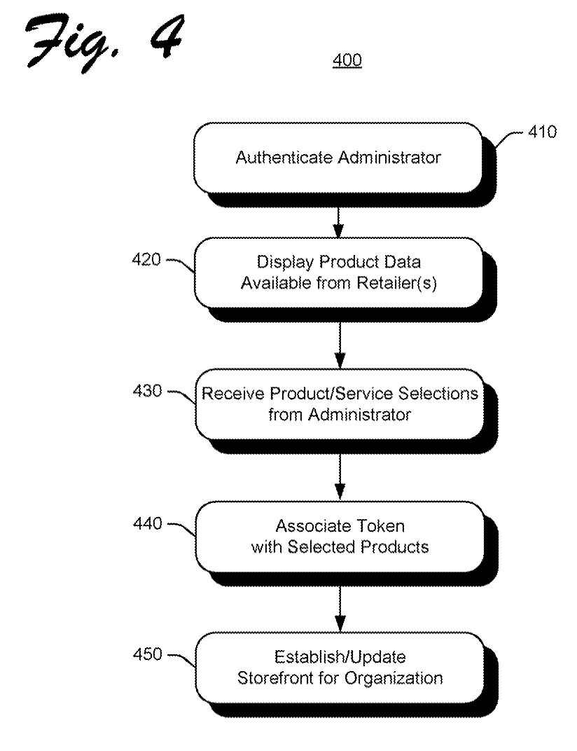

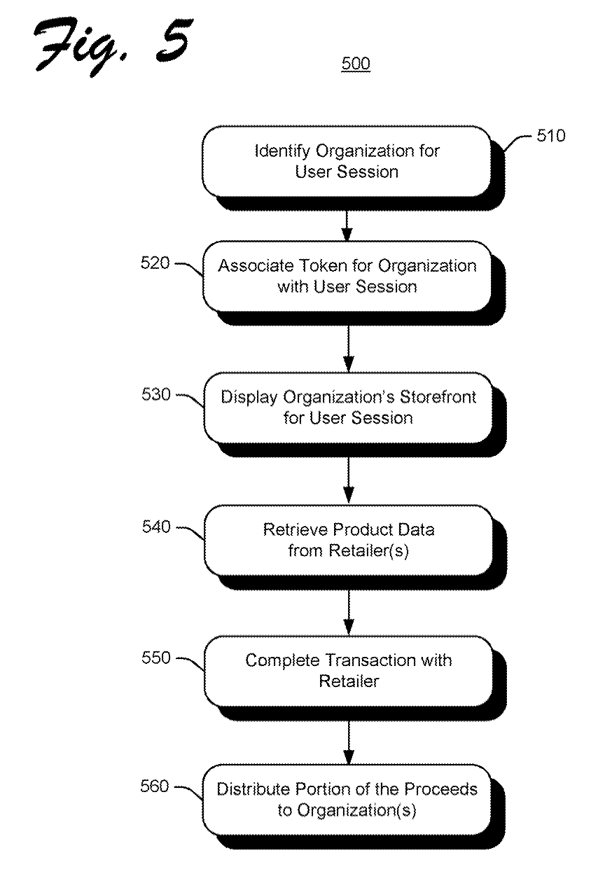

FIGS. 4 and 5 illustrate exemplary operations which may be implemented for managing retailer affiliate programs. The operations may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used.

FIG. 4 is a flowchart illustrating exemplary operations which may be implemented by a service provided for an organization to establish or modify/update a storefront. In operation 410, an administrator acting on behalf of an organization is authenticated by the service provider. Initially, authentication may include the gathering of information for the administrator and organization, such as, but not limited to, the name and contact information for the organization, proof of non-profit status, the organization's cause, and other registration information. Subsequent authentication may be based on a username and password.

In operation 420, product data that is available from one or more retailers is displayed for the administrator. Optionally, the administrator may be able to select from various product categories, price ranges, etc. so that the administrator can select products and/or services that are consistent with the organization's philosophy or other objectives. The administrator's selections are received by the service provider in operation 430.

In operation 440, the organization's token is associated with the selected products and/or services (e.g., those selected in operation 430). In operation 450, a storefront is established for the organization. Alternatively, the storefront may be updated if the storefront has already been established for the organization and changes to products and/or services were made in operation 430.

The following example is provided for purposes of illustration. In this example, an administrator for an organization can directly interact and manage the products and services available from the retailer through the organization's storefront. The service provider application provides the links, buttons or other visual designation for informing the administrator that the product and/or service they are viewing can be managed.

The administrator may be provided the ability to select a product and/or service that is being displayed to be a “Featured Product”. In this example, the administrator authenticates on the service provider web site with their registered email address and password. If the administrator is authenticated, visual navigation options are displayed for the administrator to notify them which administrative options are available for that product or service being displayed to them. A navigation option is displayed to inform them that the selection of this navigation option adds the selected product to their “Feature Product” list. The service provider system then stores a record of that product in a “Featured Product” table, and it is referenced to the organization that the administrator has authenticated rights to modify it.

Such an embodiment facilitates the ability to display for the users visiting the site to see a list of products that have been selected by the organization. For example, and organization may work with children with autism, so they may feature products or services available from the retailer that directly or indirectly relate to autism, such as, e.g., a book on children with autism.

FIG. 5 is a flow chart illustrating exemplary operations which may be implemented by a service provider to track a user's purchases and distribute payment to the organization(s) selected by the user. In operation 510, one or more organizations are identified for the user session. For example, the user may specify one or more organizations for which the user's purchases should be credited to. In operation 520, a token for each of the organization(s) is associated with the user session. Accordingly, all of the user's purchases can be readily associated with the selected organization(s).

In operation 530, the organization's storefront is displayed for the user. For example, the organization's storefront may include products and/or services selected by the organization that are available for the user to purchase. In operation 540, product data is retrieved from one or more retailer for the user session. The product data may correspond to the user's purchases. Product data may also correspond to products and/or services that the user viewed. For example, product data may also include an indication of whether the user viewed an advertisement, took a survey, etc. provided by the retailer.

In operation 550, the transaction(s) are completed with the retailer. For example, the retailer may accept shipping and payment information from the user, and ship the product and/or service to the user. In operation 560, a portion of the proceeds from the completed transaction(s) are distributed to the organization(s) (e.g., those organizations participating in the retailer's affiliate program). In an exemplary embodiment, thee service provider may also receive a portion of the proceeds. It is noted that operation 550 may occur for each product and/or service that is purchased, or after the user completes all or a portion of the purchases. It is also noted that operation 560 may occur at various intervals (e.g., monthly, after a certain dollar amount of transactions have been completed, etc.), or may occur for each transaction.

The following example is provided for purposes of illustration. In this example, purchases are tracked to the service provider, then in turn, tracked to the organization. The user may go directly to the organization's website to begin the transaction. Alternatively, the user may locate an organization via the service provider. For example, the user may submit keywords through an input box on the service provider's website, and the service provider queries its database of organizations. In another example, the user may select an organization by category. That is a list of categories may be displayed for the user, such as, e.g., “Disaster Relief”, “Environment” or “Educational” to name a few.

In any event, after the user selects an organization, a shopping interface may display products and/or services available for purchase on behalf of the organization. The user may browse, search, or get recommended products, and manage a shopping cart at the service provider system.

The service provider accepts incoming requests from the user including embedded token information to respond to the request. The service provider processes the requests. That is, after determining the type of request being made, the service provider constructs the code to respond with. For example, the response may return results formatted in HTML code or an XML format.

The service provider also determines where to get the data from, e.g., memory cache, service provider storage, or remotely. The processing of this data gives the impression to the end user that they are interfacing directly with the organization while actually viewing retailer products and/or services via the service provider. For example, the user is able to browse, search and interact with the products and/or services available from the retailer.

Optionally, a shopping cart scenario may also be made available to the user via the service provider. The shopping cart enables the user to select products and/or services and store selections at the service provider. Selections may then be issued to the retailer when the user is ready to check out and complete the transaction. The service provider system provides the processes for transferring the user's shopping cart to the proper retailer for the purchase transaction.

Regardless of whether a shopping cart is provided, the user performs the steps to complete the purchase of the selected items from the retailer. The user may also be provided mechanisms for personalization or management of their account. This may include, but is not limited to, maintaining a personal profile within the system or managing a list of their favorite organizations and/or favorite products that they may choose to purchase in the future.

Optionally, the user may also rank the quality or reliability of the organization that can be shred publicly or saved for personal use. For instance, a user may select to rate an organization by the quality of services provided to constituents.

Also optionally, the user may find other users interested in the same organization(s). When a User selects a Non Profit to be one of their favorites, they can retrieve a list of other Users on the Service Provider system that have selected that same Non Profit as one of their favorites. If the User chooses to make this information publicly accessible, their profile information may be included on the list and other Users may be able to look up the profiles of other Users on the system and network with those like-minded individuals for exchange of information and media.

In any event, completed transactions are tracked by the service provider. The retailer may provide a portion of the proceeds to the service provider, and the service provider in turn may issue a portion of the proceeds to the organization.

Optionally, the service provider may also provide reporting services that enable the organization to view certain activities or historical data related to use of the organization's storefront. For example, the reports may include a history of purchases credited to the organization, or various activities of the users or retailer.

The operations and examples shown and described with reference to FIGS. 4 and 5 are provided to illustrate exemplary implementations for managing retailer affiliate programs. It is noted that the operations are not limited to the ordering shown. Still other operations may also be implemented.

The exemplary embodiments shown and described are provided for purposes of illustration and are not intended to be limiting. Still other embodiments are also contemplated for managing retailer affiliate programs.

1. A system comprising:
a service provider enrolled in an affiliate program offered by at least one retailer;
a token identifying the service provider in the affiliate program;
a unique sub-token assigned to an organization, the unique sub-token corresponding to the token and identifying the organization; and
an electronic storefront provided for the organization, wherein all transactions with the retailer through the electronic storefront are credited to the service provider based on the token and to the organization based on the unique sub-token.

2. The system of claim 1, wherein the electronic storefront appears as an e-commerce website to a user, but all transactions at the electronic storefront are brokered by the service provider on behalf of the retailer.

3. The system of claim 2, wherein the service provider brokers transactions at the electronic storefront on behalf of a plurality of retailers.

4. The system of claim 1, wherein the service provider brokers transactions at a plurality of electronic storefronts on behalf of at least one retailer.

5. The system of claim 1, wherein the service provider stores product/service data locally to display in the electronic storefront.

6. The system of claim 1, wherein the service provider manages an electronic shopping cart locally, but the transactions are completed by the retailer when a user is ready.

7. The system of claim 1, wherein a portion of all proceeds from the transactions at the electronic storefront are paid to the service provider and another portion of all proceeds from the transactions at the electronic storefront are paid to the organization.

8. The system of claim 1, further comprising a token device containing the unique sub-token for crediting user transactions at a brick-and-mortar store to the organization.

9. The system of claim 1, wherein the organization is a non-profit organization.

10. A method comprising:
generating a plurality of tokens, each token uniquely identifying individual service providers enrolled in an affiliate program;
generating a plurality of unique sub-tokens for each of the plurality of tokens, the unique sub-tokens assigned to separate organizations;
brokering transactions by the service providers on behalf of at least one retailer; and
crediting a portion of proceeds from the brokered transactions: 1) to the service providers based on the tokens associated with the brokered transactions, and 2) to the organizations based on the unique sub-tokens associated with the brokered transactions.

11. The method of claim 10, further comprising displaying product/service data from a retailer in custom electronic storefronts for the organizations.

12. The method of claim 10, wherein the brokering transactions includes the service providers requesting product/service data from the at least one retailer for display to users wanting to purchase the product/service from the at least one retailer.

13. The method of claim 10, wherein brokering transactions includes the service providers referencing user requests for products/services to the at least one retailer.

14. The method of claim 10, further comprising offering by the organizations only a subset of products/services available from the at least one retailer.

15. The method of claim 10, further comprising offering by one organization various products/services available from a plurality of retailers together via a single electronic storefront for the organization.

16. The method of claim 10, further comprising issuing a sub-token for an organization to user for use independent of the service provider.

17. The method of claim 10, wherein an organization is identified for a transaction based on user selections.

18. The method of claim 10, further comprising connecting users with other users based on the users' interest in the same organizations.

19. A system for managing a retailer affiliate program, comprising:
token means for uniquely identifying service providers enrolled in the retailer affiliate program;
sub-token means for uniquely identifying organizations registered with the service providers; and
means for crediting a portion of proceeds a retailer receives from transactions brokered by a service provider on behalf of an organization using the token means and sub-token means.

20. The system of claim 19, further comprising custom electronic storefront means for displaying product/service data offered on behalf of an organization.
